(19) United States
(12) Patent Application Publication
(10) Pub. No.: US 2010/0096200 A1
(43) Pub. Date: Apr. 22, 2010

(54) PROTECTING STRUCTURE

(75) Inventor: Gian Luca Bombarda, Bagnolo in Piano (IT)

Correspondence Address: LAUBSCHER & LAUBSCHER, P.C., 1160 SPA ROAD, SUITE 2B, ANNAPOLIS, MD, 21403, US

(73) Assignee: JCP S.R.L., Cavezzo, MO (IT)

(21) Appl. No.: 12/526,433

(22) PCT Filed: Feb. 12, 2008
(86) PCT No.: PCT/IB08/00309

§ 371 Date: Sep. 28, 2009

(30) Foreign Application Priority Data
Feb. 15, 2007 (IT) MO2007A000048

(51) Int. Cl. B60K 16/00; B62D 25/00

(52) U.S. Cl. 180/65.31; 296/205; 296/200

(57) ABSTRACT

A protecting structure to protect a user of a vehicle having two or more wheels extends substantially as an arch above and around a zone intended to receive the user. The protecting structure is connected with a chassis of the vehicle by fixing elements.

The invention relates to a protecting structure for protecting users of vehicles with two or more wheels from impacts and/or falls.

In particular, the invention refers to a protecting structure for protecting users of vehicles with an electric motor from impacts and or falls.

Such electric-motor vehicles may comprise utility vehicles for transporting goods, for example mail, pizzas, work tools, or people, leisure and pleasure vehicles for personal use, or the like.

Protecting structures are known for protecting users of motor vehicles with two or more wheels comprising a tubular chassis.

The tubular chassis comprises an upper part and a lower part, to the lower part there being fixed the wheels, the motor, a handlebar or steering wheel, and a seat for the users.

The upper part extends as an arch above, and around, a zone of said vehicle intended for receiving the users, for example a driver or a driver plus possible passengers.

This upper part comprises an upper portion, or roof, a front portion and a rear portion, the upper portion being interposed between the front portion and the rear portion.

The upper portion, the front portion and the rear portion are coated with a coating material, for example plastics.

The upper portion bounds the zone from above that is intended for the users and serves to protect the users from atmospheric agents and from impacts in the event of the vehicle overturning.

The front portion bounds at the front the aforesaid zone and supports a windscreen for protecting, in use, users from the air, a front lamp and, laterally, a pair of rear-view mirrors.

The rear portion, which is opposite the front portion, bounds at the rear the aforesaid zone, and supports, respectively internally and externally to the zone intended for the users, a seat back and a rear lamp.

The rear portion is further laterally provided with lateral protections for protecting the users of the vehicle from lateral impacts.

A drawback of the aforesaid protecting structures is that they are not replaceable in the event of serious damage following impacts and/or falls.

This is due to the fact that such protecting structures form, and are an integral part of, the chassis of the vehicle.

This means that in the event of serious damage to the protecting structures it is not convenient to repair the vehicle, which thus has to be scrapped, with a consequent significant economical loss for the owner.

A further drawback is that such protecting structures are particularly complex and costly to make.

An object of the invention is to improve the protecting structures for protecting users of vehicles with two or more wheels.

A further object is to provide protecting structures that are easily replaceable in the event of damage.

A still further object is to obtain protecting structures that are easy and cheap to make.

According to the invention, a protecting structure is provided for protecting a user of a vehicle with two or more wheels, said protecting structure extending substantially as an arch above, and around, a zone intended for receiving said user, characterised in that there is provided fixing means for fixing said structure to a chassis of said vehicle.

Owing to this aspect of the invention it is possible to provide protecting structures that are easily replaceable in the event of damage.

In fact, said protecting structure is separated from said chassis and is removably fixable to the chassis by said fixing means.

This enables, and makes it economical, in the event of serious damage to said protecting structure, to repair said vehicle by simply replacing said damaged protecting structure with another undamaged, protecting structure.

Further, owing to said fixing means, for example comprising threaded elements, it is possible to rapidly mount/dismantle said structure from said vehicle.

Still, said protecting structure is particularly flexible, inasmuch as with a few modifications it can be fixed to a plurality of chassis of vehicles with two or more wheels.

The invention can be better understood and implemented with reference to the attached drawings that illustrate an embodiment thereof by way of non-limiting example, in which:

FIG. 1 is a side view of a protecting structure;

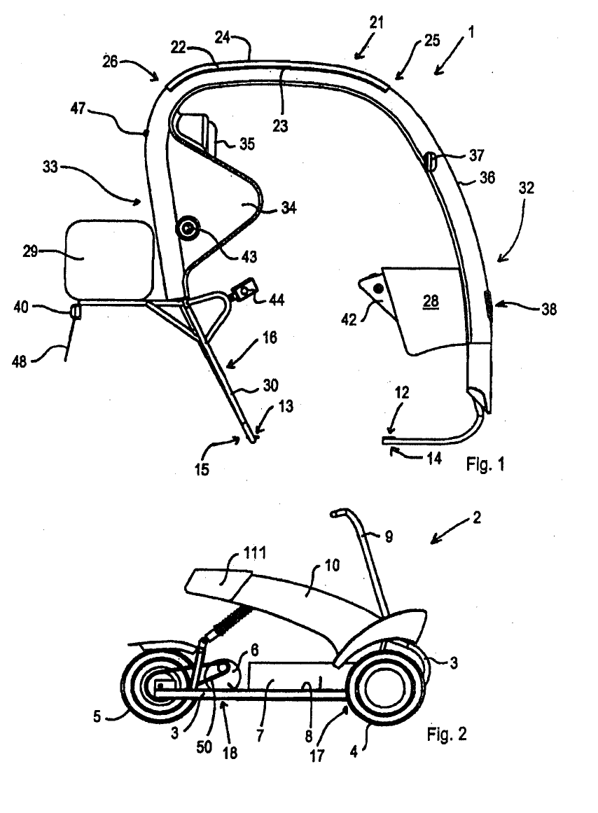

FIG. 2 is a side view of a three-wheeler vehicle with an electric motor;

FIG. 3 is a side view of the protecting structure in FIG. 1 mounted on the vehicle in FIG. 2;

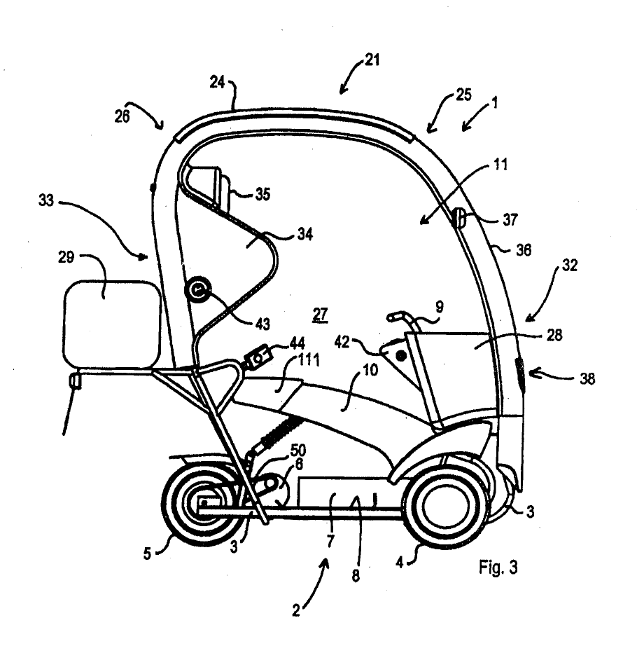

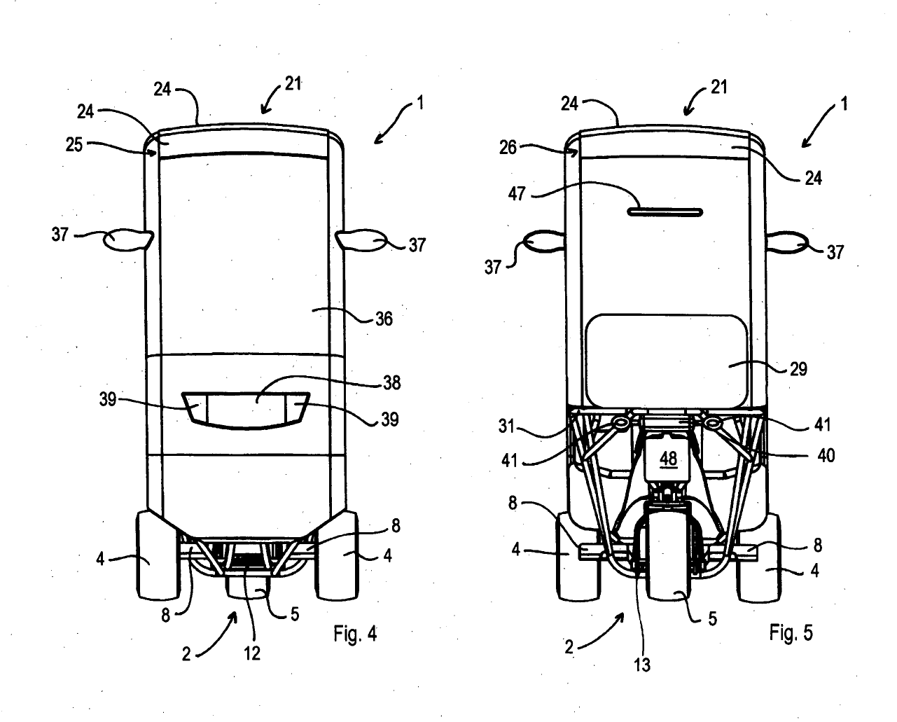

FIG. 4 is a front view of the protecting structure in FIG. 1 mounted on the vehicle in FIG. 2;

FIG. 5 is a rear view of the protecting structure in FIG. 1 mounted on the vehicle in FIG. 2;

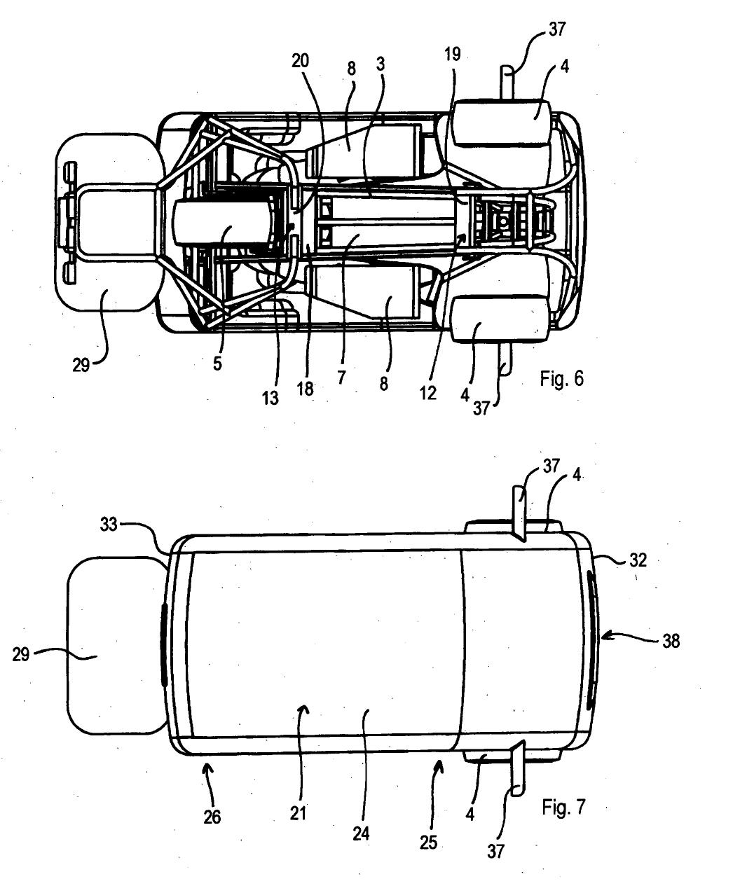

FIG. 6 is a bottom view of the protecting structure in FIG. 1 mounted on the vehicle in FIG. 2;

FIG. 7 is a top view of the protecting structure in FIG. 1 mounted on the vehicle in FIG. 2.

With reference to FIGS. 1 to 7 there is shown a protecting structure 1 for protecting from impacts and/or falls a user, who is not shown, of a vehicle 2 with an electric motor.

The vehicle 2 can be used both as a working vehicle for conveying goods and/or people and as a pleasure and leisure vehicle.

The vehicle 2 comprises a chassis 3 supporting two steering and cushioned front wheels 4, a rear driving wheel 5, a handlebar 9 for steering the front wheels 4, a cushioned arm element 10, at an end of which there is mounted a seat 11, and two footboards 8, positioned opposite the arm element 10.

The chassis 3 further supports an electric motor 6 connected by a chain 50, or a belt, to the rear wheel 5 and supplied electrically by one or more batteries 7 positioned on the chassis 3 between the footboards 8.

The protecting structure 1 extends substantially as an arch above, and around, a zone 11 intended for receiving the user, or the users, and is fixed to the chassis 3 by fixing elements 12, 13.

The fixing elements 12, 13 are positioned near respective end portions 14, 15, of a framework 16, for example a tubular framework, of the protecting structure 1, the framework 16 comprising upright elements 30 extending substantially as an arch and crosspiece elements 31 extending transversely to the aforesaid upright elements 30.

The fixing elements 12, 13 are arranged for fixing the aforesaid end portions 14, 15 to respective fixing portions 17, 18, for example bottom portions, of the chassis 3.

In an embodiment of the invention, which is not shown, the fixing portions 17, 18, comprise upper and/or front and/or rear portions of the chassis 3.

The fixing elements 12, 13 comprise respective plates 19, 20 that are fixable to the respective fixing portions 17, 18 by screws, or welding, or gluing or similar.

The protecting structure 1 further comprises a plurality of photovoltaic cells 21 arranged for supplying electric energy to the batteries 7, in order to increase the endurance of the electric motor 6. The photovoltaic cells 21 are mounted on a panel 22 fixed in a removable manner to an upper portion 23 of the framework 16.

This enables the photovoltaic cells 21 to be removed from the protecting structure 1 rapidly and simply in the event of a fault or damage to the photovoltaic cells.

It is further possible, if the protecting structure 1 has to be mounted onto vehicles without an electric motor, to fit on the upper portion 23 a further panel, which is not shown, devoid of photovoltaic cells 21 and having only the function of protecting the user from atmospheric agents.

The upper portion 23 comprises a curved supporting surface, which is not shown, arranged for supporting the panel 22, extending between a first zone 25 and a second zone 26 of the framework 16 respectively front and rear with respect to a driving position 27 of the user.

This enables the upper portion 23 to be shaped such that a surface 24 of the photovoltaic cells 21 is maximised that is available for irradiation and a certain quantity of photovoltaic cells 21 is always present and orientated in an optimal manner for receiving solar radiation.

In an embodiment of the invention, which is not shown, the upper portion 23 comprises a substantially flat surface.

In a still further embodiment of the invention, which is not shown, the upper portion 23 comprises at least a curved surface and at least a flat surface.

The protecting structure 1 further comprises a first container 28 and a second container 29 for containing objects that the user desires to convey, such as for example mail, pizzas, work tools and the like.

The first container 28 and the second container are fixed respectively to a front portion 32 and to a rear portion 33 of the framework 16, respectively inside and outside the zone 11 intended for the user, the first container 28 being interposed between the handlebar 9 and the front portion 32.

In an embodiment of the invention, which is not shown, the first container 28 and the second container 19 are fixed respectively to a front portion 32 and to a rear portion 33 of the framework 16, both inside or outside, or respectively outside and inside, the zone 11.

The protecting structure 1 further comprises lateral protecting elements 34 positioned laterally with respect to the zone 11 for protecting the user from lateral impacts.

The lateral protecting elements 34 project from the rear portion 33 towards the front portion 32 on opposite sides with respect to a seat back 35, fixed to the rear portion 33 inside the zone 11.

The protecting structure 1 further comprises a windscreen 36 positioned in the front portion 32 for protecting the users from the wind and from atmospheric agents.

In an embodiment of the invention, which is not shown, there are provided further photovoltaic cells positioned on the front portion 32 on opposite sides with respect to the windscreen 36.

To the side of the front portion 32 there are further fixed two rear-view mirrors 37 to enable a driver to look behind without turning round.

The protecting structure 1 further comprises a first lamp 38 and first direction indicators 39 fixed to the front portion 32, for example below the windscreen 36.

The protecting structure 1 is further provided with a second lamp 40, with second direction indicators 41, with a luminous braking indicator 47 and with a licence plate holder 48 fixed to the rear portion 33.

In particular, the second lamp 40, the second direction indicators 41 and the licence plate holder 48 are positioned below the second container 29, whilst the luminous braking indicator 47 is positioned above the second container 29.

In an embodiment of the invention, which is not shown, the protecting structure 1 comprises an opening obtained in the rear portion 33, suitably shaped to enable the user to see behind and laterally.

In a further embodiment of the invention, which is not shown, the aforesaid opening is closed by a transparent material.

The protecting structure 1 further comprises switching-on/switching-off means, which is not shown, for switching-on/switching-off the vehicle 2 positioned inside the zone 11 and fixed to a support 42 mounted on the first container 28.

The protecting structure 1 is further provided with indicating means for indicating a charge level of the batteries 7, which is not shown, positioned inside the zone 11 and fixed to the support 42.

The protecting structure 1 further comprises speed adjusting means, which is not shown, for adjusting a speed value of the vehicle 2, and travel switching means, which is not shown, for switching a travel direction of the vehicle 2, also positioned inside the zone 11 and fixed to the support 42.

Further, the protecting structure 1 is provided with electric plug means 43 for electrically connecting the batteries 7 to an electric energy supply network, which is not shown, such electric plug means 43 are fixed to, and unwindable from, the lateral protecting elements 34.

Lastly, the protecting structure 1 comprises seat belts, which are not shown, to retain the user inside the zone 11, fixed to, and unwindable from, the rear portion 33, inside the zone 11, arranged for being fixed to respective elements 44 positioned laterally with respect to the zone 11.

It should be noted how the protecting structure 1 is easily replaceable in the event of damage.

In fact, it is sufficient to unscrew the fixing screws to remove the protecting structure 1 from the chassis 3 of the vehicle 2.

In the event of serious damage to the protecting structure 1, this makes it economical to repair the vehicle 2, simply replacing the damaged protecting structure 1 with another undamaged protecting structure.

Further, the protecting structure 1 is particularly flexible, inasmuch as with few modifications it can be fixed on a plurality of chassis of vehicles with two or more wheels that have or do not have an electric motor.

1-29. (canceled)

30. Protecting structure for protecting a user of a vehicle with two or more wheels, said protecting structure extending substantially as an arch above, and around, a zone intended for receiving said user, and being provided with fixing elements for fixing said protecting structure to a chassis of said vehicle, said fixing elements being positioned near respective end portions of a framework of said structure for fixing said end portions to respective fixing portions of said chassis, wherein said structure is provided with photovoltaic cell elements for supplying electric energy to a battery of an electric motor of said vehicle positioned on an upper portion of said framework, said upper portion being shaped so as to maximize a surface of said photovoltaic cell elements available for irradiation, and with a panel that is fixable in a removable manner to said upper portion and is arranged for supporting said photovoltaic cell elements.

31. Structure according to claim 30, wherein said fixing portions are bottom portions of said chassis.

32. Structure according to claim 30, wherein said upper portion is shaped so as to favor said irradiation of said photovoltaic cell elements.

33. Structure according to claim 30, wherein said upper portion extends between a first zone and a second zone of said framework, respectively, front and rear with respect to a guiding position of said user.

34. Structure according to claim 30, wherein said upper portion comprises a substantially curved surface.

35. Structure according to claim 30, wherein said upper portion comprises a substantially flat surface.

36. Structure according to claim 30, and comprising containing elements for containing objects, said containing elements being fixed to said framework.

37. Structure according to claim 36, wherein said containing elements comprise a first container and a second container.

38. Structure according to claim 37, wherein said first container is fixed to a front portion of said framework.

39. Structure according to claim 37, wherein said first container is positioned inside said zone.

40. Structure according to claim 38, wherein said first container is interposed between a handlebar/steering wheel of said vehicle and said front portion.

41. Structure according to claim 37, wherein said second container is fixed to a rear portion of said framework.

42. Structure according to claim 37, wherein said second container is positioned outside said zone.

43. Structure according to claim 30, wherein said framework is a tubular framework.

44. Structure according to claim 43, wherein said tubular framework comprises upright elements shaped substantially as arches and crosspiece elements extending transversely to said upright elements.

45. Structure according to claim 30, and comprising lateral protecting elements positioned laterally with respect to said zone to protect said user from side impacts.

46. Structure according to claim 45, wherein said first container is fixed to a front portion of said framework and said second container is fixed to a rear portion of said framework and wherein said lateral protecting elements projects from said rear portion towards said front portion.

47. Structure according to claim 38, and comprising a windscreen positioned in said front portion.

48. Structure according to claim 41, wherein said first container is fixed to a front portion of said framework and said structure comprises lamps positioned in said front portion and in said rear portion.

49. Structure according to claim 37, and comprising a switching-on/switching-off device for switching-on/switching-off said vehicle positioned inside said zone and fixed to a support mounted on said first container.

50. Structure according to claim 49, and comprising an indicator for indicating a charge level of said battery positioned inside said zone and fixed to said support.

51. Structure according to claim 49, and comprising a speed adjusting device for adjusting a speed value of said vehicle positioned inside said zone and fixed to said support.

52. Structure according to claim 49, and comprising a travel switching device for switching a travel direction of said vehicle positioned inside said zone and fixed to said support.

53. Structure according to claim 45, and comprising an electric plug for connecting said battery to an electric energy supply network fixed to, and unwindable from, said lateral protecting elements.

54. Structure according to claim 41, and comprising a seatbelt positioned inside said zone to retain said user inside said zone and fixed to said rear portion.

55. Combination of a protecting structure as claimed in claim 30 and of a vehicle with an electric motor provided with two front steering wheels and with a rear driving wheel.
